(19) United States
(12) Patent Application Publication
(10) Pub. No.: US 2018/0232674 A1
(43) Pub. Date: Aug. 16, 2018

(54) METHOD AND SYSTEM FOR DETERMINING WORK TRAJECTORIES FOR A FLEET OF WORKING UNITS IN A HARVEST OPERATION

(71) Applicant: AGCO International GmbH, Neuhausen (CH)

(72) Inventor: Morten Leth Bilde, Langaa (DK)

(21) Appl. No.: 15/736,502

(22) PCT Filed: Nov. 7, 2016
(86) PCT No.: PCT/EP2016/076854

§ 371 Date: Dec. 14, 2017

(30) Foreign Application Priority Data
Nov. 5, 2015 (GB) 1519513.4
Nov. 5, 2015 (GB) 1519515.9
Nov. 5, 2015 (GB) 1519516.7
Nov. 5, 2015 (GB) 1519517.5

(51) Int. Cl. G06Q 10/06; G06Q 50/02; A01B 79/00

(52) U.S. Cl. CPC G06Q 10/06311; A01B 79/005; G06Q 50/02

(57) ABSTRACT

A method and system for determining path plans to be followed by a fleet of agricultural working units during a harvest operation includes receiving a first set of input parameters related to a crop field and receiving a second set of input parameters related to an available fleet of working units. The fleet of working units includes a harvesting machine and a crop carting unit. A computer simulation of a harvest operation is executed based upon the first and second sets of input parameters. From the simulation, path plans are generated for at least two mobile working units.

### BACKGROUND

### Field of Invention

The invention relates to agricultural harvest operations and particularly to the determination of work trajectories of multiple vehicles or work units in a harvest operation.

### Description of Related Art

Over the last decades, the productivity development in agriculture has incrementally moved from scaling of assets to optimization of assets. Agricultural machinery as well as the overall farm enterprises have grown in size and value over the years and a higher degree of input/output management has become more important for the farmer's profit.

Optimization parameters like fuel, labour, fertilizer, pesticides, soil and water preservation, relative to yield and quality of the crop are just some of the parameters any farmer needs to balance on both an operational and a strategic level. As the input costs are increasing, the impact of right or wrong decisions is increasing correspondingly. Furthermore, the dynamic nature of agriculture due to climate volatility and fluctuating crop prices makes these decisions even more difficult.

Many precision farming technologies has been developed and deployed in recent years to optimize various field operations. These technologies have though been limited to the optimization of a single vehicle/machine without taking the whole field operation into account across all involved vehicles/machines.

Moreover, the detrimental effects of heavy traffic associated with agricultural activities upon the soil and other growing media has in recent years become better recognised. Soil compaction in particular is now recognised as causing increased soil erosion, degraded growing conditions leading to yield loss, and increased runoff of pesticides. Damage caused by severe soil compaction can be very difficult and costly, if not impossible, to repair. Therefore, farmers and machinery manufacturers are placing much effort today in reducing the impact of farming activities upon the soil.

### SUMMARY OF INVENTION

In accordance with one aspect of the invention there is provided a method of determining path plans to be followed by a fleet of agricultural working units during a harvest operation, the fleet comprising at least one harvesting machine and at least one crop carting unit, the method comprising the steps of:

receiving a first set of input parameters related to a crop field;

receiving a second set of input parameters related to characteristics of each working unit in the fleet of working units;

generating path plans for at least two working units of the fleet of working units, wherein the generated path plans are based upon the first and second sets of input parameters.

The method involves determining a path plan for at least one harvester and at least one crop carting unit in a harvest operation based upon parameters relating to the crop field and to characteristics of the working units that make up the fleet. However, the benefits of this aspect of the invention increase with more working units. For example, the fleet may comprise two or more harvesters and/or two or more crop carting units.

The path plans are preferably generated so as to minimise the time taken for the harvest operation.

The harvester, or harvesters, may be combine harvesters for harvesting grain crops or forage harvesters for harvesting forage crops for example. The crop carting units may comprise a tractor and trailer configured to cart harvested crop, such as grain, from the harvester to another location, such as a grain storage facility for example.

The crop carting units may comprise in-field carting units and on-road carting units, wherein the in-field units are assigned to transporting harvested crop material from the harvester to the on-road carting units for onward transport to a storage facility for example. It should be appreciated that the crop carting units may transport crop material directly from the harvester to a storage facility as is commonly practiced today.

The generated path plans for each working unit are based upon parameters which are representative of certain characteristics or conditions of a given crop field and upon parameters which are representative of certain characteristics of each working unit. For example, the first set of input parameters may be representative of one of field location, field shape, field area, field access location, field topography, crop yield, crop quality and crop moisture. The second set of input parameters relate to the working units involved and may, by way of example, be representative of location, speed, and direction.

Moreover, the second set of input parameters may be specific to the type of working unit. For example, in the case of a combine harvester the input parameters may be representative of one of cutting width, crop throughput capacity, fuel consumption, grain bin capacity, unloading rate and cost of use per hour in relation to the combine harvester. In the case of a crop carting unit, such as a tractor and trailer, the input parameters may be representative of one of fuel consumption, transport capacity, unloading rate and cost of use per hour in relation to the at least one grain cart unit.

The input parameters may be constant wherein they do not vary throughout the harvest operation. By way of example only, constant input parameters may include the geometry of the field boundary, the cutting width of a harvester, and the total capacity of a tractor and trailer crop carting unit. Alternatively, the input parameters may be dynamic wherein they can vary throughout the harvester operation. By way of example only, dynamic input parameters may include the geometry of the remaining crop area, the available space in the grain bin of a combine harvester, and the position of a tractor and trailer crop carting unit.

Advantageously, by generating path plans for both a harvester and a crop carting unit as an integrated method, the working interaction between the different working units is taken into account thus optimising the respective path plans to minimise the time of operation. Algorithms are preferably employed to generate the path plans in accordance with the invention wherein an optimisation loop is employed to generate the best achievable set of path plans for minimising the time of operation.

In one respect, the path plans for the one or more crop carting units may be generated so as to cater for an optimised path plan for the one or more harvesters, whilst, in another respect, the path plans for the harvesters may also be generated so as to take account of optimal pathing for the available crop carting units. The path plans are preferably generated by algorithms that take account of the input parameter sets and which optimise the paths to minimise one of time, cost or distance travelled for example.

In one embodiment the method further comprises the step of receiving a user-input that represents a selected harvest strategy which is selected from a pre-determined list of harvest strategies, wherein the generated path plans are further based upon the selected harvest strategy. The harvest strategies may comprise rules that dictate where a combine harvester can travel across the given crop field, for example using controlled traffic farming.

In another example embodiment, the operator may select the number of headland turns to be made by the one or more harvesters, wherein this number is provided as an input parameter. In yet another example, a preferred direction which the harvesters must travel across the field may be defined by an operator and entered as an input parameter, so as to ensure the harvest traffic is aligned with the crop rows for example.

In yet another embodiment the generated path plans may also take into consideration a user-selected unloading strategy. In this case, the unloading strategy may be selected by a user from a list which includes at least two of a single point unloading strategy, a headland limited unloading strategy and an on-the-fly unloading strategy, the selection being received as an input parameter.

An unloading strategy may be chosen by a farmer depending on the soil conditions, the time involved, and the sizes of working units used for a given harvest operation. Different unloading strategies may have an impact on the cost, time and/or resultant soil compaction. Depending on the conditions faced during the harvester operation and on the user's priorities, the unloading strategy is selected and used as an input parameter in determining the path plans for the fleet of working units. In such an embodiment the path plans are generated so as to meet the criteria of the selected unloading strategy as set out below by way of example.

In a single point unloading strategy the harvesters are required to travel to a defined point in the crop field to unload. This strategy may be chosen when unloading e.g. on a tarp, in a container, or in a truck parked on the road.

In a headland limited unloading strategy the cart units are restricted to only travel on the headland of the field, meaning that the harvester can only unload in the headland. This strategy may be chosen to minimize soil compaction by preventing heavy cart units from travelling across the field. However, this typically incurs extra time which may be less than ideal when faced with a limited time window for harvest.

In an on-the-fly unloading strategy the cart units 16 are permitted to travel all across the field enabling the harvesters to unload at any time while they continue cutting, as long as the unloading auger is accessible. This strategy provides the most optimized operation when measured in time but at a cost of more extensive soil compaction.

In addition to the mobile working units including harvesters and crop carting units, the fleet of working units may also comprise stationary working units comprising at least one grain conditioning unit or facility such as a grain dryer or cleaner. The second set of input parameters may be related to the conditioning unit and representative of one of location, energy consumption and conditioning capacity. As such, the path plans for the harvesters and cart units for example may be based upon parameters that relate to the conditioning unit(s).

The working units may also comprise at least one grain storage unit or facility. The second set of input parameters may also be related to the grain storage unit and representative of one of location and storage capacity. As such the path plans for the harvesters and the cart units may, therefore, be based upon parameters that represent characteristics or conditions of the grain storage unit(s).

The method in accordance with this aspect of the invention outputs a plurality of path plans or work projections for a plurality of mobile working units based upon parameters that relate to those units, other mobile working units and other stationary working units that make up the fleet of working units.

In one embodiment the method may further comprise the step of generating a soil compaction map of the crop field based upon the generated path plans. This may be done before the harvest operation as a modelled soil compaction map, or after the harvest operation as a record of estimated soil compaction resulting from the vehicle traffic across the crop field.

In another embodiment, an output parameter that is representative of at least one of cost of operation and time of execution of the overall harvest operation is also generated.

The method may be exploited to assist in planning, or modelling, a harvest operation before the event. By allocating different numbers, combinations and permutations of working units to a given harvest operation and simulating the outcome by executing the method in accordance with the invention, a farmer or farm manager is able to evaluate and specify the preferred set of resources. The method serves to assist the farmer or farm manager in generating an optimized plan of the harvest operation before it is executed or completed. The method enables the user to simulate and evaluate different scenarios, including different unloading strategies and thereby allows the user to design or select the most optimal plan for a given operation.

However, in an enhanced embodiment, the method may also be adapted for implementation during a harvest operation to update the path plans based upon changes in the parameter sets received. In this case, the input parameters are periodically updated using data which becomes available as the harvest operation progresses. The generated path plans are revised accordingly and output parameters such as those related to cost, time and soil compaction for example are also updated. In such a scenario the model is dynamic and able to adapt an already-existing harvest plan according to the actual harvest scenario.

When carried out during a harvest operation the method may further comprise the step of updating the generated path plans based upon updated first and second sets of input parameters. The generated path plans may be communicated to the respective mobile working units during a harvest operation and displayed on user-terminals associated therewith or on mobile smart devices carried by the respective operators.

If, during the harvest operation, updated data for some dynamic parameters is not available, these parameters may be estimated using other known parameters. By way of example only, in the case of the journey time for a crop carting unit (between harvester and a storage facility) not being available, the journey time may be estimated using known values for the distance between the field and the storage facility, the average speed of the crop carting unit and the unloading rate of the crop carting unit. This may be the case, for example, in a simple embodiment of a system implementing the invention in which the path plans are generated for the harvester and the at least one crop carting unit in respect of the field area only, and do not include any path plan for any transport route beyond the field to the grain storage facility. In this case, the method may include the step of receiving input parameters that represent the distance between the field and the storage facility, the average speed of the crop carting unit and the unloading rate of the crop carting unit, and estimating the time absent from the field (to unload) based upon these parameters.

Whether off-line before the harvest operation, or on-line during the harvest operation the method in accordance with the invention may be implemented by a computer to simulate the harvest operation, or adapted harvest operation, wherein the simulation involves the generation of path plans based upon the aforementioned input parameter sets, and preferable optimised to minimise the time of operation.

A set of generated path plans can be segmented into incremental tasks for each individual constituent working unit such as a combine harvester or a grain carting unit. The incremental tasks, which preferably include the generated path plans, may be communicated to the operators of the mobile working units as operator information displayed on terminals or smart devices. The path plans are preferably displayed to the operators of the various working units in a manner which guides or instructs the operator to drive to the communicated working path plans or projections.

In an on-line mode carried out during a harvest operation, the generated tasks are carried out, the path plans are followed, and the harvest operation progresses, the input parameter sets may be updated and the method rerun to produce a periodically revised harvest plan in the form of a set of revised path plans.

Data collected or stored by the various working units during a harvest operation can be exploited to generate updated variable input parameters. For example, in the case of a combine, input parameters that are representative of one of combine position, combine speed, sensed yield, sensed moisture, sensed grain quality, fuel consumption, and grain bin level may be periodically updated and used to update path plans for working units involved in the harvest operation.

In the case of a grain cart unit an updated set of input parameters may be representative of one of location, speed and capacity.

In the case of a grain conditioning unit an updated set of input parameters may be representative of one of energy consumption and conditioning capacity.

In one embodiment, and by way of example, a combine may collect data related to grain moisture, wherein the conditioning capacity of a conditioning unit is a calculated value based upon the sensed moisture. In turn, the path plans of some working units, for example the grain cart units, may be updated to reroute the grain cart units to alternative conditioning units or storage facilities.

In a preferred embodiment the method is executed by a system that includes data processing means such as a personal computer, remote server, laptop computer and/or smart device. The system may be a centralised control system in which the data processing means is disposed centrally on an external server for example, and wherein communication links are provided between the server and the various harvest resources to transfer data. Alternatively, the system may be a distributed control system wherein all or some of the constituent harvest resources holds a copy of the model and generated harvest plan and wherein the constituent systems communicate with each other to keep the model and plan updated.

### BRIEF DESCRIPTION OF DRAWINGS

Further advantages will become apparent from reading the following description of specific embodiments of the invention with reference to the appended drawings in which:

FIG. 1 is a diagrammatic view of an off-line harvest operation management system configured to execute a method in accordance with an embodiment of the invention;

FIG. 2 is a flow diagram of a method of modelling off-line a harvest operation comprising a fleet of working units in accordance with an embodiment of the invention;

FIG. 3 is a schematic illustration of a displayed path plan generated from the method illustrated in FIG. 2;

FIG. 4 is a is a diagrammatic view of an on-line harvest operation management system in accordance with an embodiment of the invention;

FIG. 5 is a flow diagram of a method of modelling on-line a harvest operation comprising a fleet of working units in accordance with an embodiment of the invention;

FIGS. 6A-C show a user terminal displaying different representations of guidance commands generated by the on-line harvest operation management system of FIG. 4;

FIG. 7 shows a smart device displaying various status and task information generated by the on-line harvest operation management system of FIG. 4;

FIG. 8 is a flow diagram illustrating some causes and effects of soil compaction;

FIG. 9 is a model of a spatial contact stress profile of an example agricultural vehicle;

FIG. 10 shows two plots illustrating a modelled soil response through a layer of soil in response to a passage of an example agricultural vehicle having a front axle and a rear axle; and,

FIG. 11 is a schematic illustration of a soil compaction map generated by a system in accordance with an embodiment of the invention.

### DETAILED DESCRIPTION OF SPECIFIC EMBODIMENTS

Aspects of the invention will now be described in the following detailed description with reference to the drawings, wherein preferred embodiments are described in detail. Although aspects of the invention are described with reference to these specific preferred embodiments, it will be understood that the inventive aspects are not limited to these preferred embodiments. But to the contrary, the inventive aspects include numerous alternatives, modifications and equivalents as will become apparent from consideration of the following detailed description.

A first aspect of the invention provides a method of determining path plans for a fleet of working units in an agricultural harvest operation that can be implemented, for example, by a data processor embodied in a PC, laptop, or remote server. The method can be carried out “offline” before a harvest operation to allow a farm manager, for example, to plan and optimise the harvest operation. Alternatively, the method can be carried out “online” during a harvest operation to provide real-time optimisation and coordination of the constituent systems involved. Before the offline and online methods are explained in more detail, an overview of the constituent systems and working units, together with the associated fixed and variable parameters, will be described.

### Constituents of a Harvest Operation

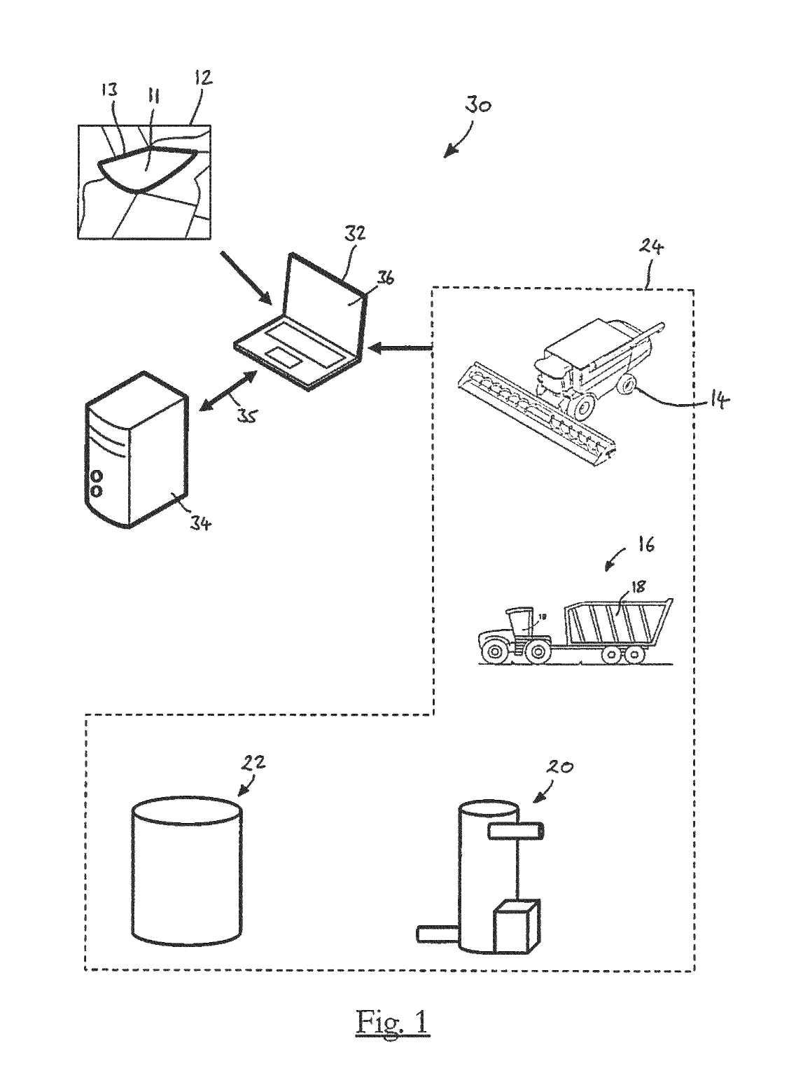

An agricultural harvest operation can be considered as a logistic chain in which crop is moved from a crop field to a storage facility. Various components or sub-systems are typically involved and these will now be described. It should be appreciated, however, that some of the described harvest stages may be omitted in some embodiments of the invention. Reference is made to FIG. 1 which illustrates the components of the harvest operation in schematic form.

### Crop Field

A crop field 11 to be harvested is represented on a map 12 which defines the boundaries 13, and thus the shape and size, of the field 11. A given crop field has associated therewith a number of fixed and variable parameters which can be input into a harvest operation model.

The fixed parameters associated with the crop field include, by way of example:

Location identifier;

Access points or gateways;

Boundaries 13;

Soil type; and,

Topography.

The variable parameters associated with the crop field include, by way of example:

Crop yield;

Crop moisture;

Ripeness;

Crop quality; and,

Soil moisture.

The fixed parameters do not change substantially over time and can be provided as input parameters with a reasonable degree of certainty. The variable parameters are dependent upon the condition of the crop in the field 11 or the soil and may vary with time due to state of ripening or weather conditions for example. The variable parameters are either estimated or measured values from remote sensing systems for example.

### Harvester

In the illustrated embodiment, the harvester is a combine harvester 14 (hereinafter referred to as “combine”) which is a mobile working unit employed to cut the crop from the crop field 11 and separate the grain from the cut crop material. It should be appreciated however that the invention is applicable to other types of harvesters such as forage harvesters and sugar cane harvesters.

The combine 14 is driven across the crop field 11 during a harvest operation. The grain is collected and stored in an on-board tank in a known manner. The volume of grain in the tank may be sensed directly using a camera-based system for example, or calculated by integrating the reading from a yield sensor over time.

A given combine has associated therewith a number of fixed and variable parameters which can be input into a harvest operation model.

The fixed parameters associated with a combine include, by way of example:

Cutting width;

Total grain bin capacity;

Maximum throughput capacity; and,

Maximum unloading rate.

The variable parameters associated with a combine include, by way of example:

Position;

Speed/direction;

Grain bin level;

Throughput capacity;

Cost of use per hour;

Fuel consumption; and,

Spatial contact stress profile.

The cutting width of a given combine is dependent upon the header attached thereto. The total grain tank capacity (when the grain tank is empty), the maximum throughput (or capacity) and maximum unloading rate are known values that can be input as a fixed parameter.

The variable parameters can change with time and may be dependent upon parameters of other sub-systems. For example, the fuel consumption is typically greater for higher moisture crops at a fixed throughput. These parameters may be sensed in real time, or estimated or calculated from average values and/or from other parameters.

The combine 14 comprises a GPS receiver which provides means to generate a signal that is representative of the position, speed and direction of the combine 14 during the harvest operation.

The spatial contact stress profile will be described later in this specification but relates to the weight and contact with the ground. The parameter is, therefore, dependent upon the weight of the vehicle which includes the load carried at a given time. The measure can be used to determine soil compaction risk.

The combine 14 comprises means to sense the yield, moisture and quality of the crop being harvested. Therefore, during a harvest operation, the combine 14 may produce signals which are representative of these variable crop field parameters and provide these signals as a system input.

A harvest operation may involve more than one combine 14, each potentially having different associated parameters.

### Crop Transport

A harvest operation typically involves a plurality of crop transport or ‘carting’ units in the form of grain carts. A fleet of grain carts may include a mixture of in-field units and on-road units. However, a fleet of carting units that is intended to operate between the combine and a storage or conditioning facility directly is envisaged.

The illustrated embodiment includes a grain cart unit 16 comprising a grain handling trailer 18 towed by an agricultural tractor 19. The grain cart unit 16 serves to collect grain unloaded by the combine 14 and transport the grain to one of an on-road grain cart unit, a conditioning facility or a storage facility. An on-road grain cart unit may comprise a larger trailer forming part of a highway truck which operates between a periphery of the field 11 and a storage facility for example.

The fixed parameters associated with grain cart unit 16 include, by way of example:

Average fuel consumption;

Transport capacity; and,

Unloading rate.

The variable parameters associated with grain cart unit include, by way of example:

Position;

Speed/direction;

Load;

Spatial contact stress profile; and,

Cost of use per hour.

A harvest operation typically involves a fleet of grain cart units, each unit potentially having different associated parameters.

### Conditioning and Storage

A harvest operation involves transporting the harvested grain to a storage facility, sometimes via a conditioning facility which is typically, although not necessarily, on the same site as the storage facility.

A grain conditioning facility, represented by 20 in FIG. 1, serves to dry and/or clean and/or cool the grain before being stored. The need for conditioning is dependent upon the state of the harvested grain and/or the intended use. For example, a grain sample harvested below 14% moisture may not require drying before being put into a store. Similarly, a grain sample containing a high level of material other than grain (MOG) intended for cattle feed may not require cleaning.

The fixed parameters associated with each conditioning facility 20 include, by way of example:

Location; and,

Maximum conditioning capacity.

The variable parameters associated with each conditioning facility 20 include, by way of example:

Actual conditioning capacity;

Energy consumption;

Humidity;

Temperature; and,

CO₂ level.

The energy consumed by a grain dryer is dependent upon a number of the other variable parameters including grain moisture, atmospheric humidity and temperature. The atmospheric parameters may be sensed locally or obtained from another observations source online for example.

Each storage facility, represented by 22 in FIG. 1, comprises one or more grain silos. Alternatively, the storage facility may comprise a covered shed-based grain store. Each grain store 22 has an associated and respective parameter representing the location and maximum storage capacity. The available storage capacity may be a measured value or a value calculated based upon a known quantity of grain delivered thereto.

1. Offline Harvest Planning

Together, the above-described harvester(s) 14, grain cart unit(s) 16, grain conditioning unit(s) 20 and grain storage unit(s) 22 provide the fleet of working units collectively designated as 24 in FIG. 1. Each harvest operation typically involves at least one of each working units described.

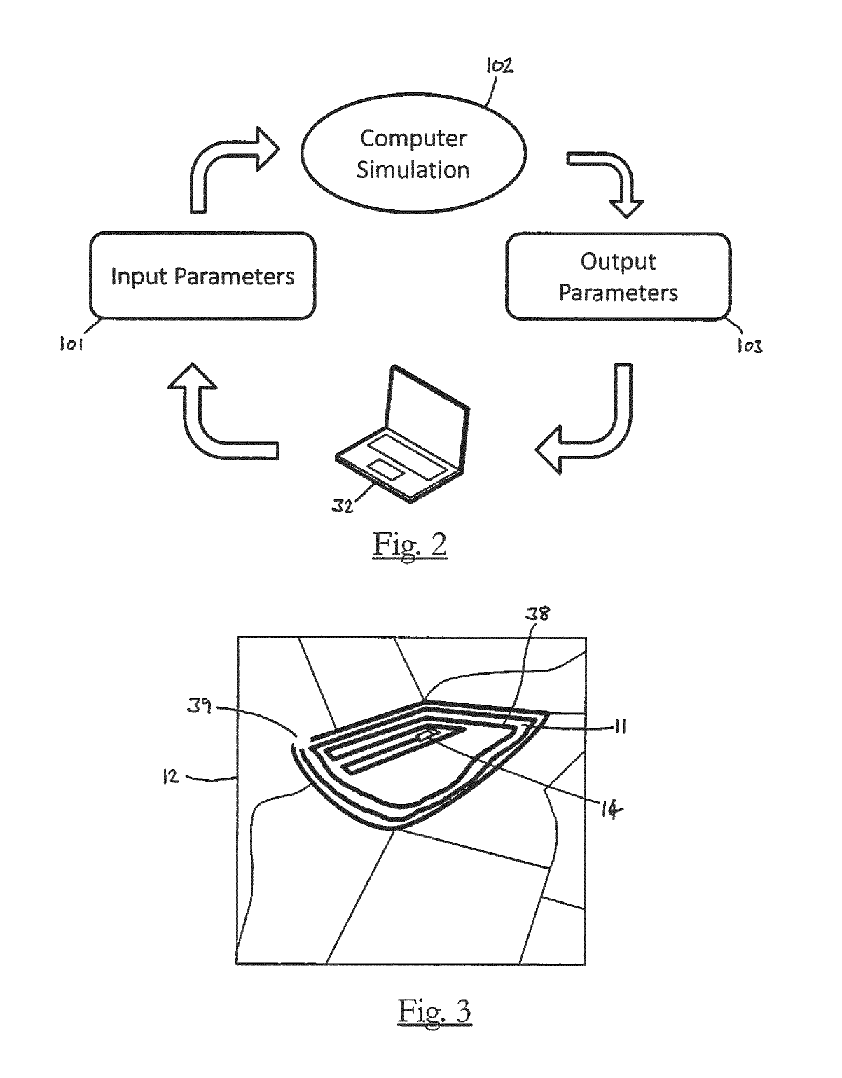

In one embodiment of the first aspect of the invention, a harvest operation management system 30 is provided. In a first mode of operation, the system 30 provides an offline tool for a farm manager to plan and optimise a harvest operation, before the execution of the harvest operation. The method implemented by the system is described with reference to FIGS. 1 and 2.

The system 30 comprises data processing means in the form of a personal computer 32 which may be located in a farm office for example. Alternatively, the data processing means may be in the form of a tablet or smart device. The computer 32 is in communication with a remote server 34 via a wired or wireless data link 35.

The computer 32 comprises control circuitry which may be embodied as custom made or commercially available processor, a central processing unit or an auxiliary processor among several processors, a semi-conductor based micro-processor (in the form of a micro-chip), a macro processor, one or more applications specific integrated circuits, a plurality of suitably configured digital logic gates, and/or other well-known electrical configurations comprising discrete elements both individually and in various combinations to coordinate the overall operation of the offline tool.

The computer 32 further comprises memory. The memory may include any one of a combination of volatile memory elements and non-volatile memory elements. The memory may store a native operating system, one or more native applications, emulation systems, emulated applications for any of a variety of operating systems and/or emulated hardware platforms, emulated operating systems etc. The memory may be physically separate from the computer 32 or may be omitted.

The computer 32 includes a display 36 and user-interface means in the form of a keyboard and mouse.

The computer 32 is configured to execute a simulation of a harvest operation based upon sets of input parameters which relate to the crop field 11 and the available harvest resources 24. In the offline mode, the parameters may be entered, or selected from predetermined lists, using the user-interface means.

### Input Parameters

In a first step 101, the input parameters are entered into the computer 32 by an operator.

A first set of input parameters relate to the crop field 11 to be harvested. The first set of input parameters is representative of at least one of, by way of example, field location, field shape, field area, field access location, field topography, an estimated crop yield, crop quality, crop moisture and soil moisture. It should be appreciated that, prior to the harvest operation, the variable field parameters (related to the crop and soil) are preferably estimated or calculated.

A second set of input parameters relate to the available fleet of working units 24. The operator firstly selects the number of each working unit and enters this data into the computer. For example, the operator may choose to model a harvest operation with one combine 14, two grain cart units 16, one conditioning facility 20 and two storage facilities 22. This example will be used to explain the following entry of input parameters.

For each working unit 24 selected, the associated input parameters are entered. The input parameters are representative of at least one of cutting width, crop throughput capacity, fuel consumption, grain bin capacity, unloading rate and cost of use in relation to the combine harvester. Furthermore, the associated input parameters are representative of at least one of respective fuel consumption, transport capacity, unloading rate and cost of use in relation to the two grain cart units. Further still, the input parameters are representative of one of location, energy consumption and conditioning capacity in relation to the at least one grain conditioning unit. Also, the input parameters are representative of one of location and storage capacity in relation to the two grain storage units.

In this first stage 101, the operator is effectively required to select a combination of harvest resources upon which the harvest operation will be modelled. In addition to the harvest resources and associated parameters, a harvest strategy and/or unloading strategy may be selected from a predetermined list. The harvest strategies relate to the ruleset of how vehicles travel across the field 11 when modelling the harvest operation.

In one example, the operator selects a harvest strategy from a pre-determined list of harvest strategies. The list may comprise a controlled traffic farming (CTF) harvest strategy in which all vehicle traffic is restricted to predefined tracks or paths in the field. Selection of the harvest strategy may be received by the computer 32 in the form of a further set of input parameters.

In another example, the operator selects the number of headland turns to be made by the one or more harvesters thus determining the width of the headland. In yet another example, a preferred direction which the harvesters must travel across the field may be defined and entered as an input parameter, so as to align the harvest traffic with the crop rows for example.

In another example, the operator selects an unloading strategy from a pre-determined list of unloading strategies. The list of unloading strategies may comprise the following:
I. Single point:—The combines are required to travel to a defined point in the field 11 or in close proximity to unload. This strategy may be chosen when unloading e.g. on a tarp, in a container, or in a truck parked on the road.
II. Headland:—This unloading strategy restricts the grain cart units 16 to only travel on the headland of the field 11, meaning that the combine 14 can only unload in the headland. This strategy may be chosen to minimize soil compaction by preventing the heavy grain cart units 16 from travelling across the field 11.
III. On-the-fly:—This unloading strategy allows the grain cart units 16 to travel all across the field enabling the combines 14 to unload at any time while they continue cutting, as long as the unloading auger is accessible. This strategy provides the most optimized operation when measured in time while sacrificing the output parameters of cost and soil compaction.

### Simulation

In a second step 102, the computer (or system) executes a method in accordance with an aspect of the invention based upon the input parameters received. The method involves simulating a harvest operation involving each of the mobile working units, namely the combine 14 and grain carts 16, and based upon the inputted sets of parameters.

### Output Parameters

In a third step 103 the computer 32 outputs the generated path plans which are based upon the inputted parameters and preferably optimised so as to minimise the time taken to complete the harvester operation. FIG. 3 illustrates an example path plan 38 for the combine 14 across field 11, starting from an access gateway 39.

The path plans may be based upon any selected harvest or unloading strategy as described above. For example, if the ‘Headland’ unloading strategy has been selected then the path plan for the grain cart units 16 will avoid a central region of the field 11. In another example, the respective path plans for the harvesters may include a headland turn path that is dependent upon the width of the headland. For example, an optimisation algorithm that determines the path plans may select a “omega-shaped turn” or a “fishtail-shaped turn” based upon the available headland width. The selection of the headland turn pattern may be based upon minimising the number of windrows trodden down by the harvester for example.

The computer 32 may also, optionally, generate an output that is representative of at least one of a cost of operation, a time of execution and a resultant soil compaction. A cost of operation and/or a time of execution may be simply presented to the operator by respective figures displayed on display 36. The resultant soil compaction may be presented on display 36 in the form of a soil compaction risk map as shown in FIG. 11 and to be discussed in more detail later in this document.

### Review and Repeat

The operator is then able to repeat the process for different resource allocations or harvest or unloading strategies. By allocating different working units to a given harvest operation and simulate the outcome, the farmer or farm manager is able to evaluate and specify the preferred set of resources. In the same manner the farmer or farm manager is able to evaluate the outcome of different harvest and unloading strategies.

It is envisaged that the computer may generate a preferred set or allocation of harvest resources based upon a selected outcome. For example, the operator may specify an upper limit to the time of execution of the harvest operation whereupon the computer 32 may optimise the executed simulation to achieve this upper limit and produce a specification of required resources.

2. Online Harvest Coordination

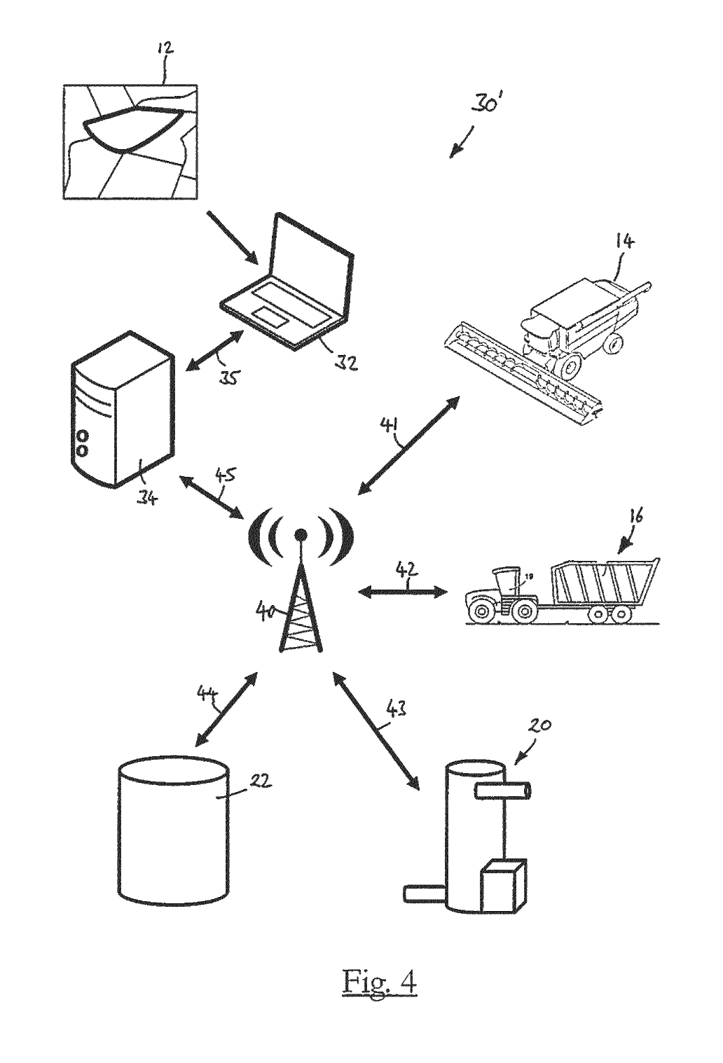

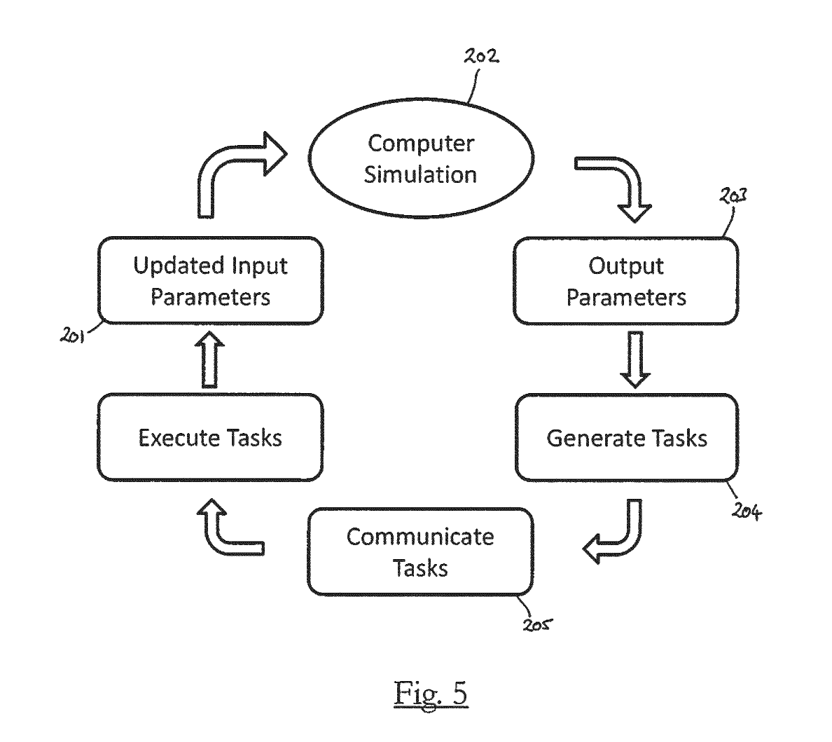

In a second mode of operation, the system 30 provides an online, or real-time, coordination tool for a farm manager to oversee and optimise a harvest operation, during the execution of the harvest operation. The method implemented by the system is described with reference to FIGS. 4 and 5.

The system 30′ is shown in the second mode of operation. The computer 32 is in communication with the remote server 34 via communication link 35. The server is in communication with the harvest resources 14,16,20,22 via a wireless network which includes an antenna 40. In an alternative communications arrangement, the system includes a distributed network in which all constituent systems hold a copy of the modelling software and the plan generated thereby. In such an arrangement, the constituent systems, including each working unit in the fleet of working units, communicate with each other. The benefit of such a distributed arrangement is that even in the event of a failed connection, a constituent system still has the latest communicated plan to follow until the failed connection is re-established.

Turning back to system 30′, a wireless communications link 41 exists between the combine 14 and antenna 40. Similarly, a wireless communications link 42 exists between each grain cart unit 16 and antenna 40. Respective wireless links 43, 44 connect the condition facility 20 and the storage facility 22 with the antenna 40. The antenna is in communication with server 34 via link 45.

The various fixed input parameters are stored on the computer 32. For example, these fixed parameters include the field location, combine cutting width and the transport capacity of the grain cart units 16.

The variable input parameters are also stored on the computer 32. However, the variable input parameters are periodically updated throughout the harvest operation as indicated by step 201 in FIG. 5. Various sensors are associated with the harvest resources 14,16,20,22, the data from which is communicated to the computer 32 via the wireless network during the harvest operation. The data from the sensors is processed before being used to update the simulation input parameters.

The variable input parameters related to the crop condition may be updated from data received from the combine 14 as it progresses through the crop. For example, a yield sensor disposed on the combine 14 may produce a signal that is indicative of crop yield, this signal being communicated to the computer to update the associated input parameter. In another example, the combine comprises a moisture sensor which measures the moisture of the grain during the harvest operation. The moisture reading may be periodically communicated to the computer so that the input parameter ‘grain moisture’ can be updated.

Other variable input parameters are communicated from the combine 14, grain cart units 16, conditioning facility 20 and storage facilities 22 throughout the harvest operation.

Some of the variable input parameters vary with varying load. For example, the spatial contact stress profile of the mobile resources 14,16 is dependent upon the real-time load of the vehicle. Such parameters may, therefore, be calculated values which are based upon a sensed or calculated load value.

With reference to the aforementioned ‘fixed’ input parameters, it should be understood that a user may update these parameters with new values during the harvest operation. For example, the location of the access point (or points) to the crop field may be changed.

In a second step 202 the computer 32 executes a software-based simulation to model the remainder of the harvest operation based upon the updated input parameters received.

In a third step 203 the computer 32 generates and outputs an updated path plan for each of the mobile working units, namely the combine 14 and grain carts 16. The updated path plans are optimised so as to minimise the time to complete the remaining harvest operation and are based upon the simulation carried out in the second step 202.

The computer 32 may also, optionally, generate an output parameter that is representative of at least one of a cost of operation, a time of execution and a resultant soil compaction. In one envisaged scenario, the sensed grain moisture may fall below a defined threshold so that the harvested grain can be transported direct from the field 11 to the grain storage facility 22 (without the requirement for drying). The simulation may show to a farm manager that the time of execution of the harvest operation is not adversely affected by the removal of one grain cart unit 16 thus allowing a reduction or reallocation in resource.

The computer simulation is repeated throughout the harvest operation in response to updated input parameters. The planning model will therefore continually adapt to the changing conditions and resource configuration to optimise the harvest operation.

As with the offline mode of operation the computer 32 may generate a preferred fleet of working units based upon a selected outcome. For example, the operator may specify an upper limit to the time of execution of the harvest operation whereupon the computer 32 may optimise the executed simulation to achieve this upper limit and produce a specification of required working units throughout the harvest operation.

In a further aspect of the second ‘online’ mode of operation, the system generates from the simulation commands related to tasks that are specific to working units, and then communicates these tasks to the relevant working units. This is represented in FIG. 5 as steps 204 and 205. The tasks may be communicated to the drivers of the combine 14 and/or grain cart units 16 by means of respective user interfaces which may include a display.

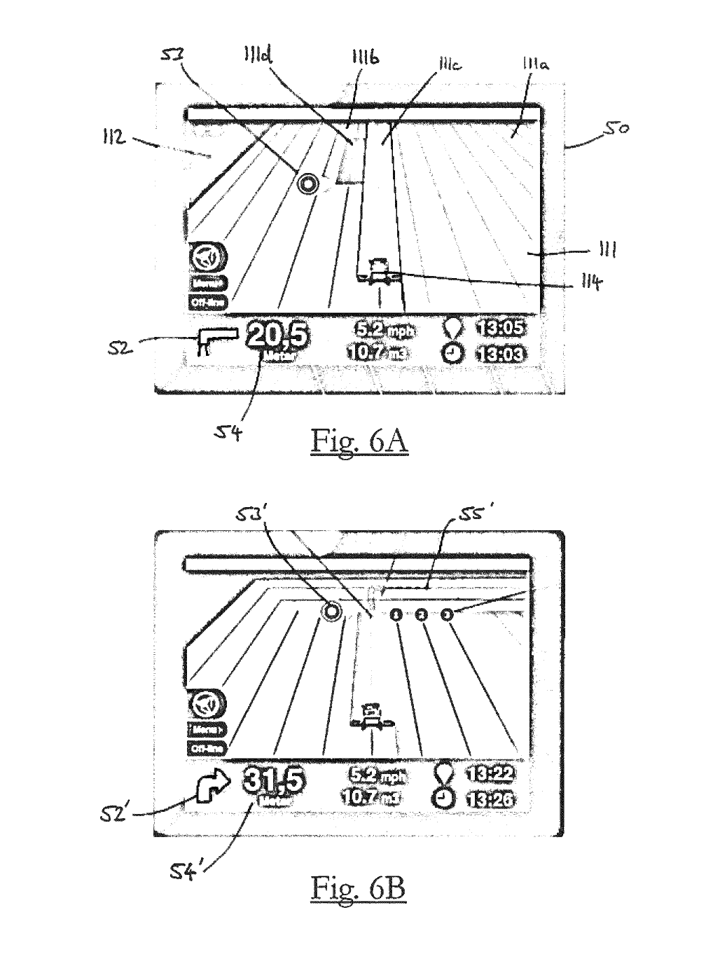

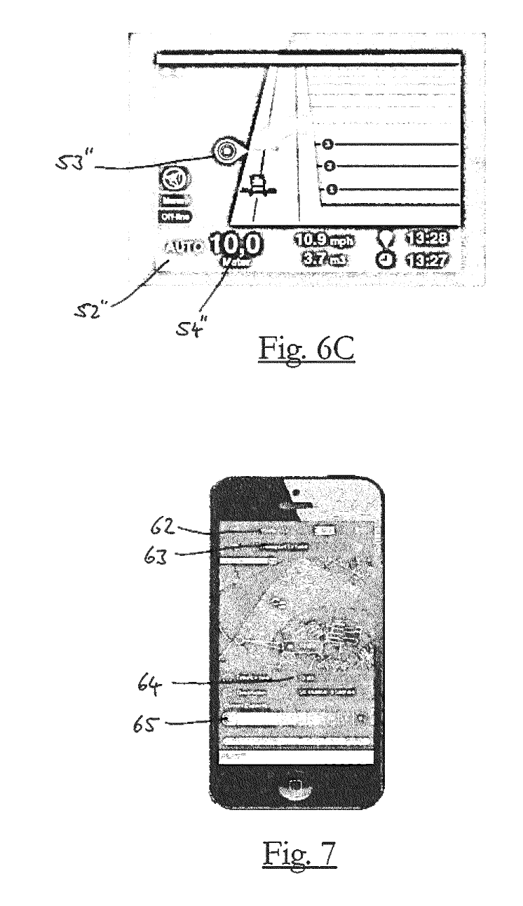

The tasks may be related to a path plan generated by the computer simulation. For example, a task may be generated that is specific to the combine 14 and informs the combine operator of the preferred path around the crop field 11. FIGS. 6A, 6B and 6C illustrate an example of a task displayed to the operator of combine 14.

With reference to FIG. 6A, a driver terminal 50 associated with the combine 14 is shown as displaying the information relating to an unloading task. The combine is represented as a graphic 114 in a graphical representation of the field 111. The graphical field representation 111 is divided into differently-coloured zones. A first zone 111a represents standing crop, whereas a second zone 111b represents an area already harvested. A third zone 111c corresponds to the swath immediately ahead of the combine 14 and is shaded with a colour which indicates to the driver that auto-steering should be active. A fourth zone 111d shows the driver where the upcoming unloading task will occur. Areas beyond the field boundary 13 are colour differently (112) with no detail to avoid confusion.

An icon 52 indicates to the driver the type of task and a graphic 53 indicates an attention point where commencement of the task is planned. The distance to the attention point is also indicated at 54.

With reference to FIG. 6B the driver terminal 50 is shown as displaying the information relating to a ‘headland entry’ task. An icon 52′ indicates to the driver the type of task and a graphic 53′ indicates an attention point where commencement of the task is planned. The distance to the attention point is also indicated at 54′. A subsequent step is indicated by dashed lines at 55′. Areas intended for manual steering are represented as zones having a different colour to areas where auto-steering is intended.

With reference to FIG. 6C the driver terminal 50 is shown as displaying the information relating to a ‘headland exit’ task. Again an icon 52″ indicates to the driver the type of task and a graphic 53″ indicates an attention point where commencement of the task is planned. The distance to the attention point is also indicated at 54″.

It is recognized that some of the constituent systems and working units involved in a harvest operation do not need the large amount of data communication associated with operation of the combine 14. An example of this is an on-road truck wherein the only data needed by the system, is to know the position of the truck and the current grain load (or remaining load capacity). For the truck driver, the only information he needs is where to go next and by when. The user interface for such constituent systems can therefore be deployed as a simple smartphone app, eliminating the need for direct communication with the vehicle electronics. An example of such app is illustrated in FIG. 7. The app displays information relating to the truck capacity 62, next task, 63, time to next task 64, and current grain load 65. A similar app could be used for interaction with other grain cart units.

In an embodiment of a second aspect of the invention the computer simulation is exploited to generate resource-specific tasks without generating output parameters that are representative of at least one of a cost of operation, a time of execution and a resultant soil compaction. A system implementing such a method may be employed for online harvest operation coordination but may be less useful for planning before the operation.

3. Grain Load Tracking

A method of monitoring capacity of grain-carrying receptacles during a harvest operation may be embodied in the system 30′ described above.

As mentioned above, the grain tank level of combine 14 may be sensed directly using a camera-based system for example, or calculated by integrating the reading from a yield sensor over time. In any case, a parameter representing the grain tank level is received, stored and periodically updated by the computer 32. Furthermore, the unloading rate of the combine 14 is also represented as an input parameter that is received and stored by the computer 32.

The load of each grain cart unit 16 is stored in the computer as a variable parameter which is a calculated value based upon the known volume of grain in the combine 14.

It should be understood that the available capacity of a grain receptacle, whether that be the combine grain tank or the grain cart, can also be determined from the maximum grain capacity and the calculated or sensed load.

During simulation, the system model virtually transfers grain volume to a grain cart unit 16 during unloading from the combine 14. In this manner, the model keeps track of the actual grain volume on the grain cart unit 16.

The calculated parameter representing grain cart load can also be exploited to update the any parameter representing load or available capacity of downstream grain cart units or storage facilities to which the grain is delivered.

In the event that a grain cart unit does not fully unload the full grain load, means may be provided to allow the operator to manually adjust the current grain volume status of their vehicle.

In one embodiment the computer carries out a further step of assigning a location or field identifier to the batch of grain which is associated with a grain transfer operation. Advantageously, this improves traceability recording allowing the source of the grain to be traced back from the storage facility for example.

4. Spatial Soil Compaction Mapping

A fourth inventive aspect provides a method of mapping soil compaction of an agricultural crop field based upon a set of path plans for a fleet of working units. Such a method can be embodied in the system 30 wherein the simulation generates an output parameter that is representative of resultant soil compaction.

By combining the knowledge about a vehicle's route across the field 11 with the knowledge about the vehicle's static soil stress at any position within the field, a soil compaction map can be compiled. A representation of a vehicle's path across a crop field can be obtained ‘offline’ in advance of the field operation, ‘online’ during the field operation, or after the field operation.

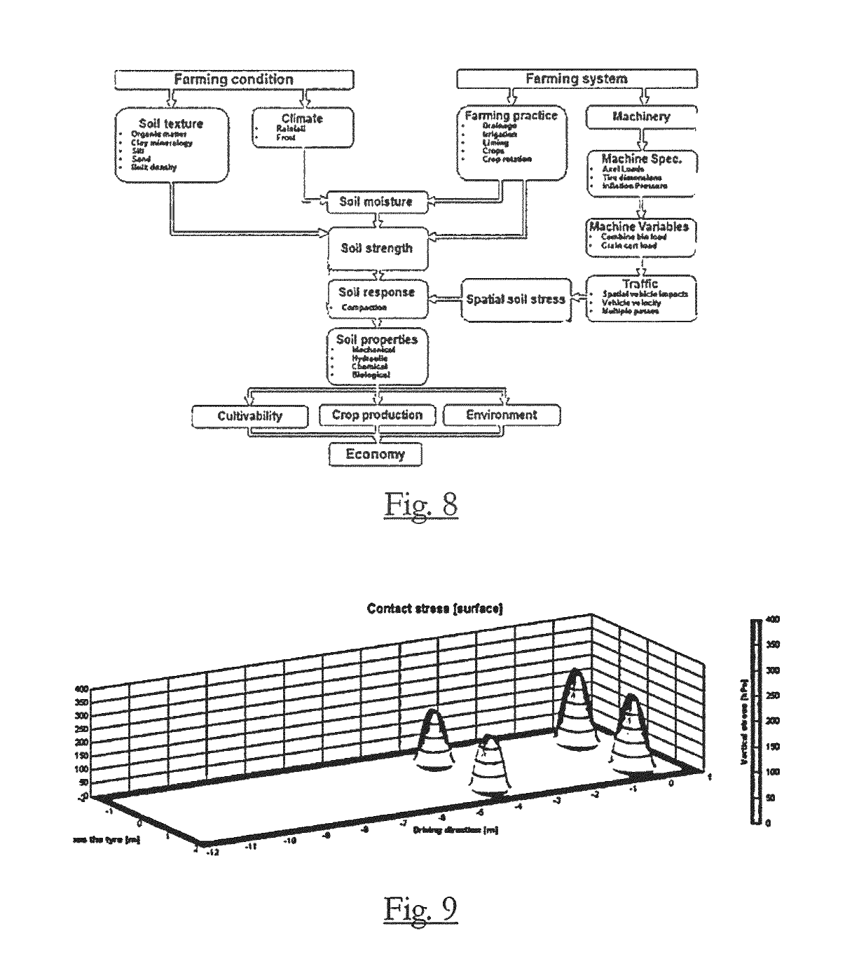

FIG. 8 sets out the various influences on, and effects of, soil compaction in a crop field. The strength of a soil layer is dependent upon the soil moisture, texture and farming practices carried out thereon. The soil strength of a given parcel of land, in one embodiment, is a calculated parameter based upon the soil moisture and texture, both of which are mentioned above as input parameters that relate to the crop field 11. In a first step of an example embodiment, the soil strength of field 11 is represented as a soil strength map that is received and stored by computer 32.

FIG. 9 shows an example spatial contact stress profile of a combine wherein stress is plotted vertically. The spatial contact stress profile of a vehicle is dependent upon its weight and distribution of such across the footprint with the ground. Alternatively, the stress profile can be considered as a pressure profile exerted by the vehicle on the ground. It can be seen from FIG. 9 that the wheels of a combine front axle exert a greater stress upon the ground that the wheels of a combine rear axle.

It should be appreciated that the spatial contact stress profile of a vehicle is a variable parameter that varies with load. Therefore, the stress profile of a combine or a grain cart unit will change with time as a harvest operation progresses due to changes in the grain load and even changes in the fuel tank level. This data may be stored on a CAN-bus of the vehicle, wherein the load data is georeferenced by GPS data.

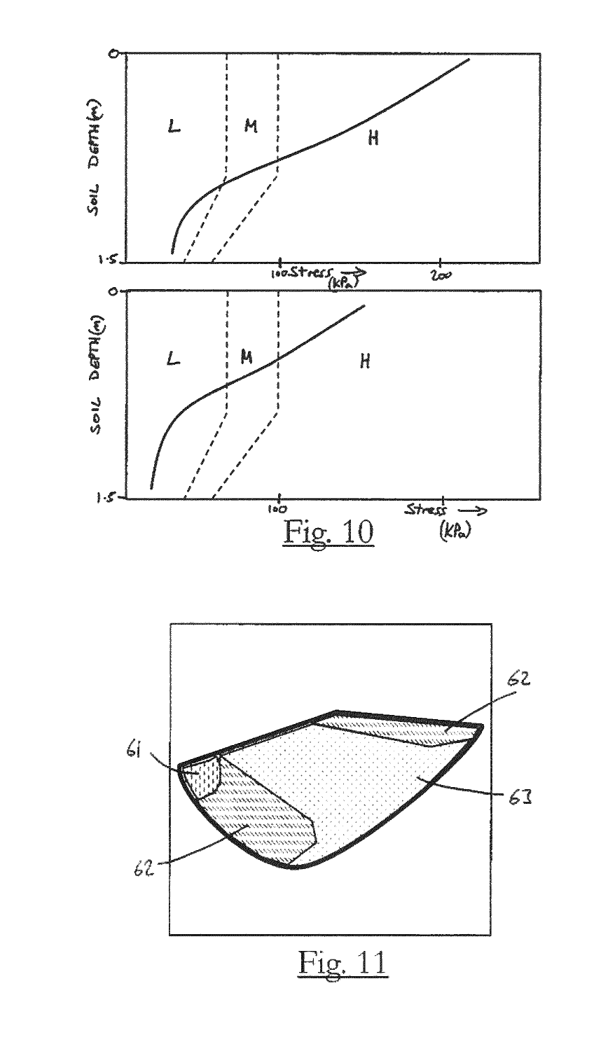

FIG. 10 shows an example soil response as a function of pressure and soil depth wherein the risk of permanent compaction is represented as high (H), medium (M) and low (L). It can be seen that the risk of soil compaction is greater for the front axle (top graph) than for the rear axle (lower graph).

As a rule of thumb, the critical depth for soil compaction in the lower soil layer is 0.5 metres. As indicted both front and rear wheels are within the high risk of compaction zone. The top soil makes up the top 0.25 m. Even though the compaction is higher in the top soil, the compaction in the soil layers below the tillage depth is much more critical, as the soil properties won't recover from the compaction.

In a second step of the example embodiment of this inventive aspect, the computer receives a spatial contact stress profile of the combine 12 and the grain cart units 16.

In a third step, the computer 32 receives a path representation of the combine 12 and grain cart units 16 across the crop field 11. The path representation may be generated from a simulation of the harvest operation before or during the event, or alternatively following collection of georeferenced vehicle path data after the harvest operation. In the latter case, the combine 14 and grain cart units 16 may be fitted with GPS receivers which generate GPS coordinates that are communicated to the computer 32 or server 34 during the harvest operation. An actual path representation of each vehicle can then be generated from these coordinates.

The aforementioned spatial contact stress profiles for each vehicle will change along the path representation of that vehicle. Therefore, the data relating to the stress profile is georeferenced with respect to the path representation.

In a fourth step, the computer 32 calculates a resultant soil compaction risk across the field based upon the soil strength map, the spatial contact soil stress profiles and the path representation. The soil compaction risk is one example of an output parameter generated by the offline simulation executed in step 102 of FIG. 2. From this output parameter a soil compaction map may be generated. FIG. 11 shows an example soil compaction risk map which represents, in different colours, area of high risk 61, medium risk 62 and low risk 63.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings.

1. A harvest operation system for harvesting a crop in a crop field comprising:
a processor for generating and storing a harvest plan and distributing harvest plan data;
a fleet of working units comprising at least one harvesting unit, at least one crop carting unit, and at least one storage unit:
at least one user interface associated with each of the harvesting and crop carting units, said user interface for receiving harvest plan data and displaying harvest plan data to an operator of the harvesting or crop carting unit:
a wireless network for communication of harvest plan data between the processor and the user interfaces;
wherein the harvest plan comprises:
path plans for each of the working units and is generated by the processor in dependence upon a first set of parameters related to the crop field; and
a second set of parameters related to each of the working units.

2. The system according to claim 1, wherein at least one of the second set of parameters is updated during the harvesting as a result of an action of a working unit.

3. The system according to claim 1, wherein the first set of parameters comprises one or more of field location, field shape, field area, field access location, field topography, estimated crop yield, estimated crop quality and estimated crop moisture.

4. The system according to claim 2, wherein the harvest plan is updated in response to the update to the at least one of the second set of parameters.

5. The system according to claim 1, wherein the second set of parameters comprises parameters relating to the at least one harvesting unit and comprises one or more of cutting width, throughput capacity, average fuel consumption, crop bin capacity, unloading rate, position, speed, direction, fuel consumption, crop bin level, throughput, cost of use and spatial contact stress profile.

6.-8. (canceled)

9. The system according to claim 1, wherein the second set of parameters comprises parameters relating to the at least one crop carting unit and comprises one or more of average fuel consumption, transport capacity, unloading rate, positions, speed, direction, fuel consumption, load, cost of use and spatial contact stress profile.

10. The system according to claim 1, wherein the fleet of working units comprises a conditioning unit connected to the wireless network.

11. The system according to claim 10, wherein the second set of parameters comprises parameters relating to the at least one conditioning unit and comprises one or more of location, energy consumption, maximum conditioning capacity, actual conditioning capacity, atmospheric humidity, grain moisture, temperature, and CO2 level.

12. The system according to claim 1, wherein the harvest plan further comprises unloading tasks which are communicated to at least one working unit.

13. The system according to claim 1, wherein the second set of parameters comprises parameters relating to the at least one storage unit and comprises one or more of location, maximum storage capacity and available storage capacity.

14. A method of harvesting a crop in a crop field, comprising the steps of:
providing a fleet of working units comprising at least one harvesting unit, at least one crop carting unit and at least one storage unit;
generating and storing on a processor a harvest plan comprising path plans for each of the working units in dependence upon a first set of parameters related to the crop field and a second set of parameters related to each of the working units;
distributing the harvest plan to one or more of the working units;
performing the harvest plan;
updating at least one of the second set of parameters during the harvesting as a result of an action of a working unit; and
updating the harvest plan in response to the update to the at least one of the second set of parameters.

15. The method according to claim 14, wherein the harvest plan further comprises unloading tasks and said unloading tasks are distributed to and performed by at least one of the working units.

16. (canceled)

17. The system according to claim 1, wherein the harvest plan further comprises a soil compaction plan.

18.-20. (canceled)

21. The system as claimed in claim 1, wherein the processor is remote from any of the working units.

22. The system as claimed in claim 1, wherein the processor is a distributed system present on one or more of the working units.
